(19) United States
(12) Patent Application Publication
(10) Pub. No.: US 2024/0076486 A1
(43) Pub. Date: Mar. 7, 2024

(54) IMPACT MODIFICATION OF STYRENIC POLYMERS WITH POLYOLEFIN ACRYLIC POLYMERS

(71) Applicants: Dow Global Technologies LLC, Midland, MI (US); Rohm and Haas Company, Collegeville, PA (US)

(72) Inventors: Carlos Alfonso Cruz, Collegeville, PA (US); Liang Chen, Sewickley, PA (US); Steven C. Brown, Elverson, PA (US); Pu Luo, King Of Prussia, PA (US)

(21) Appl. No.: 17/767,598

(22) PCT Filed: Oct. 14, 2020
(86) PCT No.: PCT/US2020/055462

§ 371 Date: Apr. 8, 2022

Related U.S. Application Data
(60) Provisional application No. 62/916,905, filed on Oct. 18, 2019.

(51) Int. Cl. C08L 51/06; C08F 255/08; C08L 25/12

(52) U.S. Cl. CPC C08L 51/06; C08F 255/08; C08L 25/12

(57) ABSTRACT

Disclosed is an impact modified resin comprises a matrix polymer resin and an impact modifier. The impact modifier comprises particles of a crosslinked polyolefin elastomer having one or more (meth)acrylic monomers grafted to the crosslinked polyolefin elastomer particles. The matrix polymer resin is a styrenic polymer.

### FIELD OF THE INVENTION

The field of this invention is impact modification of styrenic polymers.

### BACKGROUND

Styrene-acrylonitrile (SAN) and other styrene-based copolymers have very attractive properties, such as hardness, low density, high temperature and chemical resistance and ease of processability. SAN copolymers are widely used in goods such as housewares, packaging, appliances, interior automotive lenses, industrial battery cases and medical parts (Encyclopedia of Polymer Science and Technology, pp. 174-203). Due to their inherent brittleness, SAN copolymer are often blended with rubbers to enhance their impact resistance. Amongst other rubbers, polybutadiene or poly (butyl acrylate) grafted with SAN, ethylene-vinyl acetate (EVA) copolymers, chlorinated polyethylene copolymers (CPE), as well as ethylene-propylene diene monomer (EPDM) polymers either grafted with SAN or blended with suitable EVA copolymers, or even silicone-based rubbers, have been used to impact modify SAN.

When the rubber used for impact modification is butadiene-based, the final blend of SAN and SAN-grafted butadiene, is called ABS, a widely known material in the plastics industry and used in many applications, such as automobile parts, including radiator grilles, headlight housings, mirror housings and others; in appliances, the second major application for ABS, the plastic is used in refrigerator doors and liners. Still, an important issue with ABS is its poor weather resistance, stemming from the use of butadiene in the rubber phase.

Poly (butyl acrylate)-based rubbers, grafted with a rigid shell, are well known in the art. In particular, acrylonitrile-styrene-acrylate materials (ASA) consist of a butyl acrylate rubber core, grafted with a SAN shell and dispersed into a SAN matrix. Alternatively, the grafted rigid shell can be made from methyl methacrylate, MMA, or a copolymer of MMA with another monomer. In those materials, weatherability is very high, but the level of impact achieved is less than that observed for ABS.

Another alternative to toughen SAN copolymers is to use polyolefin-based elastomers grafted with suitable monomers that make them compatible with SAN. Several examples exist of this methodology, as, for example, ethylene-propylene-diene monomer rubber, EPDM, grafted with SAN itself or ethylene-butene copolymers (EB) grafted with methyl methacrylate-acrylonitrile (MAN) copolymers (CN101684169 B). These materials are generically known as acrylonitrile-ethylene-elastomer-styrene, or AES, and various versions exist, such as adding an SAN-compatible copolymer to facilitate the dispersion and bonding of ungrafted EPDM or similar elastomers. There are some inconveniences to this approach, such as the grafting reaction taking place in a solvent for the EPDM-SAN material, or the combination of solvent-aqueous suspension for EB-MAN grafts. Processing variability might affect both the grafting and the compatibilization approaches.

Certain acrylic impact modifier (AIM) bimodal blends have produced about 150 J/m at 35 wt. % loading. ASA Geloyd GRXTWE270M shows 145 J/m using a 40 wt. % loading. Others have observed that EXL-2330 shows better performance than other acrylics in an SAN with 25% AN (A. C. Steenbrink, V. M. Litvinov and R. J. Gaymans, Polymer Vol. 39 No. 20, pp. 4817-4825, 1998).

KR2017054642A discloses the use of an ethylene-α-olefin copolymer emulsified via high speed homogenization and grafted with SAN. The modifier is useful for impact-modifying SAN while providing high gloss and good colorability, and offering good weatherability in comparison with ABS.

There is still a need, however, for impact modifiers for styrenic polymers that offer both impact resistance and weatherability.

### SUMMARY OF THE INVENTION

Disclosed herein is an impact modified resin comprising an impact modifier and a matrix polymer resin. The impact modifier comprises particles of a crosslinked polyolefin elastomer, wherein at least one (meth)acrylic monomer is grafted to the crosslinked polyolefin elastomer particles. The matrix polymer resin comprises a styrenic polymer.

Also disclosed are articles comprising the impact modified resin.

### DETAILED DESCRIPTION OF THE INVENTION

As used herein, the following terms have the designated definitions, unless the context clearly indicates otherwise.

A hydrocarbon is a compound containing only atoms of hydrogen and carbon. An atom other than carbon and hydrogen is a “hetero” atom. A chemical group that contains one or more hetero atom is a “hetero” group.

A “polymer,” as used herein is a relatively large molecule made up of the reaction products of smaller chemical repeat units. Polymers may have structures that are linear, branched, star shaped, looped, hyperbranched, crosslinked, or a combination thereof; polymers may have a single type of repeat unit (“homopolymers”) or they may have more than one type of repeat unit (“copolymers”). Copolymers may have the various types of repeat units arranged randomly, in sequence, in blocks, in other arrangements, or in any mixture or combination thereof. Polymers have weight-average molecular weight of 1,000 daltons or higher. Polymers that are sufficiently crosslinked that they become insoluble in any solvent are considered to have infinite molecular weight.

Molecules that can react with each other to form the repeat units of a polymer are known herein as “monomers.” The repeat units so formed are known herein as “polymerized units” of the monomer.

An olefin monomer is a monomer that is a hydrocarbon having one or more carbon-carbon double bond and having no aromatic rings.

A polymer having more than 50% by weight polymerized units of olefin monomers is a polyolefin. Vinyl aromatic monomers are vinyl monomers in which one or more of R1, R2, R3, and R4 contains one or more aromatic rings. (Meth)acrylate means acrylate or methacrylate. (Meth)acrylic means acrylic or methacrylate. (Meth)acrylic monomers are monomers selected from acrylic acid, methacrylic acid, alkyl esters thereof, substituted-alkyl esters thereof, amides thereof, N-substituted amides thereof, acrylonitrile, methacrylonitrile, and mixtures thereof. Substituents may be, for example, hydroxyl groups, alkyl groups, aromatic groups, groups containing non-aromatic carbon-carbon double bonds, or other groups, or combinations thereof. A (meth)acrylic polymer is a polymer having more than 50% by weight polymerized units of (meth)acrylic monomers.

An alpha-olefin is a hydrocarbon having 3 or more carbon atoms and having exactly one carbon-carbon double bond, which is located at a terminal carbon atom. That is, in an alpha-olefin, at least one of the two carbon atoms in the carbon-carbon double bond also has two hydrogen atoms attached. A diene is a hydrocarbon having exactly two carbon-carbon double bonds. A diene may be conjugated or non-conjugated.

A polyolefin that is made exclusively of hydrocarbon monomers is considered to be a hydrocarbon, even if a small number of hetero groups is attached to the polyolefin, as fragments from an initiator and/or chain transfer agent. In hydrocarbon polyolefins, the mole ratio of hetero atoms to polymerized units of all monomers is 0.001:1 or lower. A polyolefin that is not a hydrocarbon is a non-hydrocarbon polyolefin.

As used herein, a crosslinking agent is a compound having two or more carbon-carbon double bonds.

A dispersion is a collection of particles that are distributed throughout a continuous liquid medium. A continuous liquid medium is an aqueous medium if the liquid medium is 50% or more water by weight based on the weight of the liquid medium. A dispersion has “solids” content that is determined by weighing the dispersion (WDISP), then drying the dispersion in an infrared moisture balance at 150° C. until the weight is stable, then determining the weight of the dry residue (WDRY), and then solids=100*WDRY/WDISP.

An initiator is a compound that, when exposed to initiation conditions, produces radical moieties that are capable of initiating free-radical polymerization. The nature of the initiation condition varies among initiators. Some examples: thermal initiators produce radical moieties when heated to a sufficiently high temperature; and photoinitiators produce radical moieties when exposed to radiation of sufficiently short wavelength and sufficiently high intensity. As another example, a redox initiator is a pair of molecules that react together in an oxidation/reduction reaction to produce radical moieties; initiation conditions obtain when both members of the pair are present and can react with each other.

Emulsion polymerization is a process in which monomer emulsion droplets, water-soluble initiator, and optional seed particles are present in an aqueous medium. During emulsion polymerization, monomer molecules transfer from the monomer emulsion droplets to the particles where polymerization takes place, which may be separate particles formed during polymerization or may be the seed particles, or a combination thereof.

Polymers may be characterized by their glass transition temperature (Tg), which is measured by differential scanning calorimetry (DSC), at a scan rate of 10° C./min, using the inflection point method.

A collection of particles may be characterized by the volume mean diameter.

Ratios are characterized herein as follows. For example, if a ratio is said to be 5:1 or higher, it is meant that the ratio may be 5:1 or 6:1 or 100:1 but may not be 4:1. To state this characterization in a general way, if a ratio is said to be X:1 or higher, then the ratio is Y:1, where Y is greater than or equal to X. Similarly, for example, if a ratio is said to be 2:1 or lower, it is meant that the ratio may be 2:1 or 1:1 or 0.001:1 but may not be 3:1. To state this characterization in a general way, if a ratio is said to be Z:1 or lower, then the ratio is W:1, where W is less than or equal to Z.

A first aspect of the present invention relates to an impact modified resin comprising an impact modifier and a matrix polymer resin, wherein the impact modifier comprises particles of a crosslinked polyolefin elastomer, wherein one or more (meth)acrylic monomers are grafted to the crosslinked polyolefin elastomer particles, and the matrix polymer resin comprises a styrenic polymer.

Preferably, the crosslinked polyolefin elastomer particles form a core and the one or more (meth)acrylic monomers grafted to the crosslinked polyolefin elastomer particles at least partially form a shell around the core.

The impact modifier is preferably prepared by dispersing the polyolefin elastomer using a extrusion-emulsion process, such as the process disclosed in International Publication No. WO 2019/133168 and U.S. Pat. No. 10,131,775, the disclosures of which are incorporated herein by reference.

Preferably, the volume average particle diameter of the dispersion of polyolefin elastomer particles ranges from 50 nm to 2500 nm. The polyolefin elastomer particles may be 100 nm or larger; more preferably 150 nm or larger; more preferably 200 nm or larger; or more preferably 250 nm or larger. Preferably, the volume average particle diameter of the dispersion of initial polyolefin particles is 2000 nm or smaller; more preferably 1500 nm or smaller; more preferably 1000 nm or smaller; or more preferably 800 nm or smaller.

A high-shear mechanical dispersion process may allow the polyolefin elastomer particles to be formed in an aqueous phase without the use of a solvent. Additionally, this process allows the size of the polyolefin elastomer particles to be set

The amount of total polyolefin in the initial polyolefin elastomer particles is, by weight based on the total solid weight of the dispersion, preferably 50% or more; more preferably 60% or more; more preferably 70% or more; more preferably 80% or more. The amount of total polyolefin polymer in the initial polyolefin particles is, by weight based on the total solid weight of the dispersion, preferably 98% or less; more preferably 96% or less.

The initial polyolefin elastomer particles preferably have Tg of 50° C. or lower; more preferably 30° C. or lower; more preferably 15° C. or lower; more preferably 0° C. or lower; more preferably −15° C. or lower.

The polyolefin elastomer may be selected from polyolefin homopolymers and copolymers. The polyolefin elastomer may comprise a single polyolefin elastomer, a blend of two or more polyolefin elastomers, or a blend of one or more polyolefin elastomers and one or more additional polymer.

Examples of polyolefins include, but are not limited to, homopolymers and copolymers of one or more alpha-olefins such as ethylene, propylene, 1-butene, 3-methyl-1-butene, 4-methyl-1-pentene, 3-methyl-1-pentene, 1-heptene, 1-hexene, 1-octene, 1-decene, and 1-dodecene, as typically represented by polyethylene, polypropylene, poly-1-butene, poly-3-methyl-1-butene, poly-3-methyl-1-pentene, poly-4-methyl-1-pentene, ethylene-propylene copolymer, ethylene-1-butene copolymer, and propylene-1-butene copolymer; copolymers of an alpha-olefin with a conjugated or non-conjugated diene, as typically represented by ethylenebutadiene copolymer and ethylene-ethylidene norbornene copolymer; and polyolefins such as copolymers of two or more alpha-olefins with a conjugated or non-conjugated diene, as typically represented by ethylene-propylene-butadiene copolymer, ethylene-propylenedicyclopentadiene copolymer, ethylene-propylene-1,5-hexadiene copolymer, and ethylenepropylene-ethylidene norbornene copolymer; ethylene-vinyl compound copolymers such as ethylene-vinyl acetate copolymer, ethylene-vinyl alcohol copolymer, ethylene-vinyl chloride copolymer, ethylene acrylic acid or ethylene-(meth)acrylic acid copolymers, and ethylene-(meth)acrylate copolymer. These resins may be used either alone or in combinations of two or more.

In selected embodiments, the polyolefin may, for example, comprise one or more polyolefins selected from the group consisting of ethylene-alpha olefin copolymers, propylene-alpha olefin copolymers, and olefin block copolymers. In particular, in select embodiments, the polyolefin may comprise one or more non-polar polyolefins.

In specific embodiments, polyolefins such as polypropylene, polyethylene, copolymers thereof, and blends thereof, as well as ethylene-propylene-diene terpolymers, may be used. In some embodiments, exemplary olefinic polymers include homogeneous polymers, as described in U.S. Pat. No. 3,645,992; high density polyethylene (HDPE), as described in U.S. Pat. No. 4,076,698; heterogeneously branched linear low density polyethylene (LLDPE); heterogeneously branched ultra low linear density polyethylene (ULDPE); homogeneously branched, linear ethylene/alpha-olefin copolymers; homogeneously branched, substantially linear ethylene/alpha-olefin polymers, which can be prepared, for example, by processes disclosed in U.S. Pat. Nos. 5,272,236 and 5,278,272, the disclosures of which are incorporated herein by reference; and high pressure, free radical polymerized ethylene polymers and copolymers such as low density polyethylene (LDPE) or ethylene vinyl acetate polymers (EVA).

In one particular embodiment, the polyolefin is a propylene/alpha-olefin copolymer, which is characterized as having substantially isotactic propylene sequences. “Substantially isotactic propylene sequences” means that the sequences have an isotactic triad (mm) measured by ¹³C NMR of greater than about 0.85; in the alternative, greater than about 0.90; in another alternative, greater than about 0.92; and in another alternative, greater than about 0.93. Isotactic triads are well-known in the art and are described in, for example, U.S. Pat. No. 5,504,172 and International Publication No. WO 00/01745, which refer to the isotactic sequence in terms of a triad unit in the copolymer molecular chain determined by ¹³C NMR spectra. The propylene/alpha-olefin copolymer comprises units derived from propylene and polymeric units derived from one or more alpha-olefin comonomers. Exemplary comonomers utilized to manufacture the propylene/alpha-olefin copolymer are C₂, and C₄ to C₁₀ alpha-olefins; for example, C₂, C₄, C₆ and C₈ alpha-olefins.

The olefin copolymer may have a melt flow rate in the range of from 1 to 1500 g/10 minutes, measured in accordance with ASTM D-1238 (at 190° C./2.16 Kg). All individual values and subranges from 1 to 1500 g/10 minutes are included herein and disclosed herein; for example, the melt flow rate can be from a lower limit of 1 g/10 minutes, 2 g/10 minutes, 3 g/10 minutes, 4 g/10 minutes, 5 g/10 minutes 100 g/10 minutes, 200 g/10 minutes, 500 g/10 minutes, 800 g/10 minutes, 1000 g/10 minutes, 1300 g/10 minutes; or 1400 g/10 minutes to an upper limit of 1500 g/10 minutes, 1250 g/10 minutes, 1000 g/10 minutes, 800 g/10 minutes, 500 g/10 minutes, 100 g/10 minutes, 50 g/10 minutes, 40 g/10 minutes, and 30 g/10 minutes. For example, the propylene/alpha-olefin copolymer may have a melt flow rate in the range of from 1 to 1500 g/10 minutes; or from 1 to 500 g/10 minutes; or from 500 to 1500 g/10 minutes; or from 500 to 1250 g/10 minutes; or from 300 to 1300 g/10 minutes; or from 5 to 30 g/10 minutes.

The olefin copolymer has a molecular weight distribution (MWD), defined as weight average molecular weight divided by number average molecular weight (Mw/Mn) of 3.5 or less; in the alternative 3.0 or less; or in another alternative from 1.8 to 3.0. Such olefin copolymers are commercially available from The Dow Chemical Company, under the tradename VERSIFY™ and ENGAGE™, or from ExxonMobil Chemical Company, under the tradename VISTAMAXX™ and EXACT™.

In other selected embodiments, olefin block copolymers, e.g., ethylene multi-block copolymer, such as those described in the International Publication No. WO2005/090427 and U.S. Patent Application Publication No. US 2006/0199930, incorporated herein by reference to the extent describing such olefin block copolymers, may be used as the polyolefin. Such olefin block copolymer may be an ethylene/α-olefin interpolymer:
(a) having a M_{w}/Mₙ from about 1.7 to about 3.5, at least one melting point, Tₘ, in degrees Celsius, and a density, d, in grams/cubic centimeter, wherein the numerical values of Tₘ and d corresponding to the relationship:

Tₘ>−2002.9+4538.5(d)−2422.2(d)²; or
(b) having a M_{w}/Mₙ from about 1.7 to about 3.5, and being characterized by a heat of fusion, ΔH in J/g, and a delta quantity, ΔT, in degrees Celsius defined as the temperature difference between the tallest DSC peak and the tallest CRYSTAF peak, wherein the numerical values of ΔT and ΔH having the following relationships:

ΔT>−0.1299(ΔH)+62.81 for ΔH greater than zero and up to 130 J/g,

ΔT≥48° C. for ΔH greater than 130 J/g,

wherein the CRYSTAF peak being determined using at least 5 percent of the cumulative polymer, and if less than 5 percent of the polymer having an identifiable CRYSTAF peak, then the CRYSTAF temperature being 30° C.; or
(c) being characterized by an elastic recovery, Re, in percent at 300 percent strain and 1 cycle measured with a compression-molded film of the ethylene/α-olefin interpolymer, and having a density, d, in grams/cubic centimeter, wherein the numerical values of Re and d satisfying the following relationship when ethylene/α-olefin interpolymer being substantially free of a cross-linked phase:

Re>1481−1629(d); or
(d) having a molecular fraction which elutes between 40° C. and 130° C. when fractionated using TREF, characterized in that the fraction having a molar comonomer content of at least 5 percent higher than that of a comparable random ethylene interpolymer fraction eluting between the same temperatures, wherein said comparable random ethylene interpolymer having the same comonomer(s) and having a melt index, density, and molar comonomer content (based on the whole polymer) within 10 percent of that of the ethylene/α-olefin interpolymer; or
(e) having a storage modulus at 25° C., G′ (25° C.), and a storage modulus at 100° C., G′ (100° C.), wherein the ratio of G′ (25° C.) to G′ (100° C.) being in the range of about 1:1 to about 9:1.

Such olefin block copolymer, e.g. ethylene/α-olefin interpolymer may also:
(a) have a molecular fraction which elutes between 40° C. and 130° C. when fractionated using TREF, characterized in that the fraction having a block index of at least 0.5 and up to about 1 and a molecular weight distribution, M_{w}/Mₙ, greater than about 1.3; or
(b) have an average block index greater than zero and up to about 1.0 and a molecular weight distribution, M_{w}/Mₙ, greater than about 1.3.

In certain embodiments, the polyolefin may, for example, comprise one or more polar polyolefins, having a polar group as either a comonomer or grafted monomer. Exemplary polar polyolefins include, but are not limited to, ethylene-acrylic acid (EAA) and ethylene-methacrylic acid copolymers, such as those available under the trademarks PRIMACOR™, commercially available from The Dow Chemical Company, NUCREL™ commercially available from E.I. DuPont de Nemours, and ESCOR™, commercially available from ExxonMobil Chemical Company and described in U.S. Pat. Nos. 4,599,392, 4,988,781, and 5,938,437, each of which is incorporated herein by reference in its entirety. Other exemplary base polymers include, but are not limited to, ethylene ethyl acrylate (EEA) copolymer, ethylene methyl methacrylate (EMMA), and ethylene butyl acrylate (EBA).

In one embodiment, the polar polyolefin may be selected from the group consisting of ethylene-acrylic acid (EAA) copolymer, ethylene-methacrylic acid copolymer, and combinations thereof, and the stabilizing agent may, for example, comprise a polar polyolefin selected from the group consisting of ethylene-acrylic acid (EAA) copolymer, ethylene-methacrylic acid copolymer, and combinations thereof; provided, however, that base polymer may, for example, have a lower acid number, measured according to ASTM D-974, than the stabilizing agent.

Polyolefins that are copolymers may be statistical copolymers, block copolymers, graft copolymers, copolymers having other structure, or mixtures thereof. Preferred are statistical copolymers.

The polyolefin elastomer particles are then crosslinked. Preferred crosslinking agents are chosen from polyolefins having carbon-carbon double bonds (“polyolefin crosslinking agents”) and compounds having molecular weight of 500 or less and having two or more carbon-carbon double bonds (“monomer crosslinking agents”). Among polyolefin crosslinking agents, preferred are homopolymers and copolymers that contain polymerized units of one or more diene. Among monomer crosslinking agents, preferred are those with two or more carbon-carbon double bonds; more preferably 3 or more carbon-carbon double bonds. Suitable monomer crosslinking agents include butanediol diacrylate, butanediol dimethacrylate, ethylene glycol diacrylate, ethylene glycol dimethacrylate, divinyl benzene, diethylene glycol diacrylate, diethylene glycol dimethacrylate, diallyl maleate, allyl methacrylate, diallyl phthalate, triallyl phthalate, trimethylolpropane triacrylate, trimethylolpropane trimethacrylate, triallyl isocyanurate, and 1,3,5,7-tetravinyl-1,3,5,7-tetramethylcyclotetrasiloxane, blends thereof and combinations of two or more thereof.

The amount of crosslinking agent is, by weight based on the total solid weight of the dispersion of initial polyolefin particles, preferably 0.5% or more; more preferably 1% or more; more preferably 1.5% or more. The amount of crosslinking agent is, by weight based on the total solid weight of the dispersion of initial polyolefin particles, preferably 20% or less; more preferably 15% or less.

The dispersion of polyolefin elastomer particles may also contain one or more surfactant. Preferred surfactants are anionic surfactants, which have a hydrocarbon group of 8 or more carbon atoms and an anionic group. The hydrocarbon group may be linear, branched, aromatic, or a combination thereof; preferred are linear hydrocarbon groups. An anionic group is a chemical group that, in water at pH of 7, carries a negative charge. Preferred anionic groups are phosphate groups, phosphonate groups, carboxylate groups, sulfate groups, and sulfonate groups; more preferred are sulfate groups. Preferred anionic surfactants also contain the group —(CH2CH2O)n-. When the group —(CH2CH2O)n- is present, it is preferably bonded to the sulfate group. The index n is 1 or more, preferably 2 or more. The index n is preferably 20 or less; more preferably 15 or less; more preferably 10 or less; more preferably 6 or less; more preferably 4 or less; more preferably 3 or less.

The amount of surfactant in the dispersion of polyolefin elastomer particles is, by weight based on the total solid weight of the dispersion, preferably 0.5% or more; more preferably 1% or more; more preferably 2% or more; more preferably 3% or more. The amount of surfactant in the dispersion polyolefin elastomer particles is, by weight based on the total solid weight of the dispersion, preferably 10% or less; more preferably 8% or less; more preferably 6% or less; more preferably 4% or less.

Preferably, the volume average particle diameter of the crosslinked polyolefin particles is 100 nm or larger; more preferably 150 nm or larger; more preferably 200 nm or larger; more preferably 250 nm or larger. Preferably, the volume average particle diameter of the crosslinked polyolefin particles is 2000 nm or smaller; more preferably 1000 nm or smaller; more preferably 750 nm or smaller; more preferably 500 nm or smaller.

One or more (meth)acrylic monomers are grafted to the crosslinked polyolefin elastomer particles to form a composition polymer composition. The (meth)acrylic monomers may be grafted to the polyolefin elastomer particles by emulsion polymerization. Preferably, the grafted (meth)acrylic monomers at least partially form an acrylic shell on the core of crosslinked polyolefin elastomer particles.

Preferably, the (meth)acrylic monomers are selected from the group consisting of C₁ to C₁₈ (meth)acrylates, such as, for example, methyl (meth)acrylate, ethyl (meth)acrylate, propyl (meth)acrylate, butyl (meth)acrylate, 2-ethyl hexyl acrylate, hexyl acrylate, ethylhexyl methacrylate, stearyl acrylate, benzyl acrylate, cyclohexyl methacrylate, isobornyl methacrylate, tetrahydrofurfuryl methacrylate, cyclopentyl methacrylate, trifluoroethylmethacrylate, hydroxyethylmethacrylate, dicyclopentadienyl methacrylate, and combinations thereof. More preferably, the (meth)acrylic monomers comprise a combination of methyl (meth)acrylate and butyl (meth)acrylate monomers, and even more preferably, a combination of methyl methacrylate and butyl acrylate monomers.

The (meth)acrylic monomers bay be functionalized, nonfunctionalized, or a combination thereof. Examples of functionalized (meth)acrylic monomers include but are not limited to acrylic acid, methacrylic acid, glycidyl methacrylate, allyl methacrylate, hydroxyethyl methacrylate, and acrylamide.

Preferably, the Tg of the grafted (meth)acrylic monomers is higher than 50° C., and more preferably, higher than 75° C.

The weight ratio of the polyolefin elastomer to (meth)acrylic monomers in the composite polymer composition preferably ranges from 50:50 to 90:10, more preferably, from 60:40 to 85:15, and even more preferably, from 70:30 to 80:20.

One or more crosslinking and/or graft-linking agents may optionally be added to the emulsion polymerization. Exemplary crosslinking agents include, for example, divinylbenzene; vinyl group-containing monomers including; triallyl (iso)cyanurate, and triallyl trimellitate; (poly)alkylene glycol di(meth)acrylate compounds including ethylene glycol dimethacrylate (EGDMA), diethylene glycol dimethacrylate, 1, 6-hexanediol di(meth)acrylate, (poly)ethylene glycol di(meth)acrylate, (poly)propylene glycol di(meth)acrylate, (poly)tetramethylene glycol di(meth)acrylate, pentaerythritol tetra(meth)acrylate, pentaerythritol tri(meth)acrylate, pentaerythritol di(meth)acrylate, trimethylolpropane tri(meth)acrylate, dipentaerythritol hexa(meth)acrylate, dipentaerythritol penta(meth)acrylate, and glycerol tri(meth)acrylate and mixtures and combination thereof. Exemplary graft-linking agents include, for example, allyl methacrylate, diallyl maleate and allyl acryloxypropionate

The particles may be spray dried or freeze dried to form the impact modifier.

The impact modifier can added to a matrix polymer resin to form an impact modified resin. Preferably, the matrix polymer resin is a styrenic polymer. Even more preferably, the styrenic polymer is a styrene-acrylonitrile copolymer (SAN). SAN contains 60% to 90% by weight polymerized units of styrene and 10% to 40% by weight polymerized units of acrylonitrile, such as, for example, 70% to 80% by weight polymerized units of styrene and 20% to 30%. In SAN polymers, the sum of the weight percentages of styrene and acrylonitrile is 70% or more. Polymerized units of other monomers, such as, for example, alkyl (meth)acrylates monomers, may be present.

Preferably, the impact modifier is present in the impact modified resin in an amount ranging from 20 to 50 wt. % relative to the total weight of the impact modifier and the matrix polymer resin. More preferably, the impact modifier is present in the impact modified resin in an amount ranging from 25 to 45 wt. % relative to the total weight of the impact modifier and the matrix polymer resin. Even more preferably, the impact modifier is present in the impact modified resin in an amount ranging from 30 to 40 wt. % relative to the total weight of the impact modifier and the matrix polymer resin.

The impact modified resin may further comprise one or more additives selected from a colorant (e.g., pigment and/or dye), a UV and/or light stabilizer, a process aid, an antioxidant, a flame retardant and/or smoke suppressant, a heat stabilizer, and a lubricant. These components are known in the art and can be used according to conventional practice.

The impact modified resin may be formed by any method. Preferably, mixture of matrix polymer and impact modifier particles is heated to be in a melt state, and the mixture is subjected to mechanical shear. For example, powder of matrix polymer may be mixed with powder form of impact modifier particles, at a temperature low enough so that the matrix polymer does not melt, and then the mixture of powder and powder may be fed to an extruder, which heats the mixture to form a melt and applies shear to the mixture. For another example, powder of matrix polymer and powder form of impact modifier particles may be fed separately to an extruder, which then provides heat and shear. It is contemplated that mechanical shear will intimately mix the polymer particles with the resin polymer, so that the powder particles break up and then the individual polymer particles are distributed in the matrix polymer.

The impact modified resin may be used to form articles such as automobile parts, including radiator grills, headlight housings, mirror housings, and others, and appliance parts, including refrigerator doors and liners.

### Examples

A polyolefin elastomer core (POD or POD Seed) was prepared from an elastomer (Engage™ 8842, The Dow Chemical Company), which was extruded into an aqueous phase with a surfactant and other stabilizers, as listed below in Table 1.

TABLE 1

| CORE ID | Composition |
|---|---|
| Core 1 | Engage8842x/Licocene 4351/Retain 3000/Empicol/TAIC |
| | (79/5/10/4/2) |
| | solids 43.24 wt % |
| | pH 4.99 |
| | phosphate surf, large PS |
| Core 2 | Engage8137/Licocene 4351/Retain 3000/SLEP/TAIC |
| | (81/5/10/2/2) |
| | solids 41.27 wt % |
| | 717 nm |

The polyolefin acrylic modifier (POA) was produced by first crosslinking the elastomeric core particles. Triallyl isocyanurate (TAIL) was used for that purpose. A rigid shell, made out of methyl methacrylate/butyl acrylate in a 98/2 proportion by weight, was grafted onto the elastomeric core particles. The core to shell ratio was between 75 and 80 weight percent for the core and 25 to 20 weight percent for the shell, as specified below in Table 2.

TABLE 2

| POA | Core ID (Crosslinker) | Core/Shell Ratio |
|---|---|---|
| POA-11c | Core 1 (TAIC) | 80/20 |
| POA-13 | Core 1 (TAIC) | 75/25 |
| POA-28B | Core 2 (TAIC) | 80/20 |

Performance was evaluated by preparing blends of SAN and the modifiers in a two-roll mill with milling for 5 min at 170° C. and molding at 4 min at 180° C. The SAN was a 78/22 styrene-acrylonitrile copolymer.

Table 3 shows the first results obtained at 30 weight percent loading of modifier. All modifiers enhanced the impact strength of SAN (PN-128100, a 78/22 styrene-acrylonitrile copolymer) at room temperature (notched Izod impact according to ASTM 256), but both POA core/shells according to the present invention showed a far superior performance. Comparative Example C1 is SAN without any modifier. Comparative Examples C2 and C3 contain all acrylic impact modifiers. Examples E1 and E2 contain the impact modifiers POA-11c and POA-13 as described in Table 2 above.

TABLE 3
Notched Izod Performance (30 wt. % Modifier)

| | | Notched | | | | | | |
|---|---|---|---|---|---|---|---|---|
| | | Izod Impact | | | | | | Particle |
| | | | Std. | J/m | Rubber | Rubber | Shell | Size |
| Example | Modifier¹ | Mean | Dev. | % Ductility | Type² | % | Type³ | (nm) |
| C1 | None | 13 | 0 | 0 | None | 0 | None | — |
| C2 | KM-376 | 42 | 2 | 0 | BA | 94 | MMA | 170 |
| C3 | EXL-2330 | 55 | 3 | 0 | BA | 80 | MMA | 600 |
| E1 | POA-11c | 160 | 57 | 60 | Polyolefin | 80 | MMA/ | 300 |
| | | | | | (Engage | | BA | |
| | | | | | 8842) | | | |
| E2 | POA-13 | 181 | 14 | 90 | Polyolefin | 75 | MMA/ | 300 |
| | | | | | (Engage | | BA | |
| | | | | | 8842) | | | |

¹Modifiers: KM-376 is PARALOID ™ KM-376 from The Dow Chemical Company; EXL-2330 is PARALOID EXL ™ 2330 from The Dow Chemical Company
²Rubber Type: BA is butyl acrylate
³Shell Type: MMA is methyl methacrylate; MMA/BA is methyl methacrylate and butyl acrylate in a 98:2 weight ratio

Table 4 below, shows a follow-up experiment, where a butadiene-based ABS-type modifier, Blendex 338 from Galata Chemicals, was compared with two different types of POAs, as well as an MBS and other acrylics in SAN (78/22 styrene-acrylonitrile, AS128 from Chimei). Comparative Example C4 used Blendex 338 as the modifier. Comparative Example C5 used PARALOID EXL-2668 as the modifier. Example E3 used a ENGAGE™ 8842 core with a MMA/BA shell in an 80/20 ratio as the modifier. Example E4 used POA-28B from Table 2 above as the modifier. Comparative Example C6 used Kane Ace™ FM-40 from Kaneka as the modifier. Comparative Example C7 used PARALOID™ KM-355P from The Dow Chemical Company as the modifier. Example E5 used a blend of two different modifiers: PARALOID™ KM-355P and POA-28B in a 50/50 weight ratio. The loading used was 35 wt. %, which is more typical of an ABS or ASA material. Temperature processing and molding conditions were 10° C. higher in this case, 185° C. and 195° C., respectively, as some early stiffening of the blend was observed in the previous experiments, when taking the molten mass from the two-roll mill to the mold for pressing.

Once again, the POA core/shell produced high impact that was higher than any of the other modifiers tested. In contrast, POA-28B, based, as well, on a different α-olefin, did not produce an equally high impact performance, likely due to the larger particle size. Furthermore, bimodal blends of that modifier with an acrylic core/shell of smaller particle size (KM-355P), using a 1 to 1 blend ratio by weight, did not produce synergism, as SAN is known to show.

TABLE 4
Notched Izod Performance (35 wt. % Modifier)

| | | Notched | | | | | | |
|---|---|---|---|---|---|---|---|---|
| | | Izod Impact | | J/m | | | | Particle |
| | | | Std. | % | Rubber | Rubber | Shell | Size |
| Example | Modifier | Mean | Dev. | Ductility | Type¹ | % | Type² | (nm) |
| C4 | Blendex | 202 | 27 | 90 | Bd | 70 | SAN | 100- |
| | 338 | | | | | | | 700 |
| C5 | EXL- | 90 | 27 | 0 | Bd/St | 75 | MMA/EA | 350 |
| | 2668 | | | | | | | |
| E3 | POA- | 246 | 22 | 100 | Polyolefin | 80 | MMA/BA | 325 |
| | 5702 | | | | (Engage | | | |
| | | | | | 8842) | | | |
| E4 | POA- | 121 | 6 | 10 | Polyolefin | 80 | MMA/BA | 717 |
| | 28B | | | | (Engage | | | |
| | | | | | 8137) | | | |
| C6 | FM- | 103 | 5 | 0 | BA | 95 | MMA | 120 |
| | 40 | | | | | | | |
| C7 | KM- | 42 | 14 | 0 | BA | 88 | MMA/BA | 150 |
| | 355P | | | | | | | |
| E5 | POA- | 64 | 4 | 0 | Polyolefin/BA | 80/88 | MMA/BA | 800/150 |
| | 28B/ | | | | | | | |
| | KM- | | | | | | | |
| | 355P | | | | | | | |
| | (50/50) | | | | | | | |

¹Rubber Type: Bd is butadiene; Bd/St is butadiene/styrene; BA is butyl acrylate
²Shell Type: SAN is styrene-acrylonitrile; MMA is methyl methacrylate; MMA/BA is methyl methacrylate and butyl acrylate in a 98:2 weight ratio

Table 5 below, shows a comparison of conventionally used SAN impact modifiers (Comparative Examples C8 to C11) and an example according to the present invention, Example E6. Comparative Example C8 uses an industry standard impact modifier, MRC SX006 from Mitsubishi Chemical, which is a silicone-butyl acrylate-styrene-acrylonitrile composition. Comparative Example C9 used KLM-6930-1 with 2.5% DC52 from The Dow Chemical Company as the modifier. Comparative Example C10 used Kane Ace™ FM-40 from Kaneka as the modifier. Comparative Example C11 used PARALOID™ KM-357P from The Dow Chemical Company as the modifier. Example E6 an impact modifier according to the present invention having a core formed of Engage 8137/licocene 4351/Retain 3000/sodium-oleate/Empicol ESB/TAIC in a ratio of 80/5/10/1.5/1.5/2, with a 98/2 MMA/BA shell, a core:shell ratio of 80:20, and a particle size of 250 nm. The loading used was 40 wt. %, of the impact modifier in the SAN. Performance was evaluated by preparing blends of SAN and the modifiers in a two-roll mill with milling for 5 min at 170° C. and molding at 4 min at 180° C. The SAN was a 78/22 styrene-acrylonitrile copolymer.

TABLE 5
Comparison of Impact Performance

| | | | Notched Izod @ 23° C. | | | MFI |
|---|---|---|---|---|---|---|
| Example | Particle Size (nm) | Loading | (J/m) | STD | % Ductility | (g/10 min) |
| C8 | 100 | 40% | 125 | 11.7 | 100% | 13.43 |
| C9 | 130 | 40% | 118 | 5.9 | 100% | 24.81 |
| C10 | 100 | 40% | 101 | 7.5 | 0% | 7.62 |
| C11 | 350 | 40% | 101 | 8.5 | 0% | 6.16 |
| E6 | 450 | 40% | 371 | 15.5 | 100% | 9.25 |

1. An impact modified resin comprising an impact modifier and a matrix polymer resin, wherein the impact modifier comprises particles of a crosslinked polyolefin elastomer, wherein one or more (meth)acrylic monomer are grafted to the crosslinked polyolefin elastomer particles, and the matrix polymer resin comprises a styrenic polymer.

2. The impact modified resin of claim 1 wherein the polyolefin elastomer comprises a first polyolefin elastomer and at least one additional component selected from an additional polyolefin elastomer, a random copolymer, and a block copolymer.

3. The impact modified resin of claim 1 wherein the polyolefin elastomer is selected from the group consisting of ethylene homopolymers, ethylene/α-olefin copolymers, ethylene/α-olefin block copolymers, propylene homopolymers, propylene/α-olefin copolymers, and propylene/α-olefin block copolymers.

4. The impact modified resin of claim 1 wherein the polyolefin elastomer is selected from an ethylene-octene copolymer and an ethylene-butene copolymer.

5. The impact modified resin of claim 1 wherein the one or more (meth)acrylic monomers are selected from methyl (meth)acrylate, ethyl (meth)acrylate, propyl (meth)acrylate, and butyl (meth)acrylate.

6. The impact modified resin according to claim 1 wherein the styrenic copolymer is a styrene-acrylonitrile copolymer.

7. The impact modified resin according to claim 1, wherein the particles of the crosslinked polyolefin resin have an average particle size ranging from 200 to 1000 nm.

8. The impact modified resin according to claim 7, wherein the particles of the crosslinked polyolefin resin have an average particle size ranging from 300 to 800 nm.

9. The impact modified resin according to claim 1, wherein the impact modifier is present in an amount ranging from 20 to 50 wt. % relative to the total weight of the impact modifier and the matrix polymer resin.

10. An article comprising the impact modified resin according to claim 1.
